(19) United States
(12) Patent Application Publication
(10) Pub. No.: US 2025/0080874 A1
(43) Pub. Date: Mar. 6, 2025

(54) SYSTEMS AND METHODS FOR CONTROLLING FEATURES OF A STRUCTURE

(71) Applicant: The AZEK Group LLC, Chicago, IL (US)

(72) Inventors: Christopher Scott SELZER, Dawsonville, GA (US); Mark MCKENNA, East Grand Rapids, MI (US); Brett WILLINK, Grand Rapids, MI (US); Calvin Michaels KING, Grand Rapids, MI (US); Nathan Dean BOWEN, Kalamazoo, MI (US)

(21) Appl. No.: 18/818,305

(22) Filed: Aug. 28, 2024

Related U.S. Application Data
(60) Provisional application No. 63/605,540, filed on Dec. 3, 2023.
(60) Provisional application No. 63/535,949, filed on Aug. 31, 2023.

(51) Int. Cl. H04N 25/75; H04N 25/77

(52) U.S. Cl. CPC H04N 25/75; H04N 25/77

(57) ABSTRACT

Aspects provided herein provide methods, systems, and computer-useable instructions for receiving an image, extracting a pixel state data for each pixel of the set of pixels, each of the pixel state data defining a pixel state comprised of characteristics of a pixel. A set of instructions are generated identifying operations to change the state of a first light of a lighting system from an initial state to a pixel state of a first pixel of the set of pixels which are transmitted to the lighting system causing a first light associated with the lighting system to change from an initial state to the pixel state. Aspects include receiving instructions in a first communication protocol, generating instructions in a second communication protocol by converting the instructions and transmitting it to a second computing device which transmits the instructions to a plurality of integrated structural devices.

### CROSS REFERENCE TO RELATED APPLICATIONS

This application claims the benefit of U.S. Provisional Application No. 63/605,540, filed on Dec. 3, 2023, and U.S. Provisional Application No. 63/535,949, filed Aug. 31, 2023, which are incorporated herein in their entirety.

### BACKGROUND

Certain building structures, e.g., a deck or other outdoor structure, may include one or more integrated structural devices. However, in certain building structure systems, there are limitations to the methods for communicating with the integrated features and further limitations to the instructions, which may be received by the integrated features.

### BRIEF SUMMARY

Building structures may have any number of integrated structural devices used to change various aspects of the building structure. For example, structures may comprise temperature control components, lighting control components, audio control components, or any other integrated structural device which may change an aspect of the overall building structure. In combination, manipulation of the settings (e.g., state) of integrated structural device facilitate creating an appealing ambiance for an end user. This ambiance can be dynamically modified to match changing environmental conditions, end user desire, or both.

In some embodiments, a single master control module are utilized by a user to facilitate changes in states of each of these integrated structural devices through any number of instructions entered at the module itself, or transmitted to the control module by a user computing device. In some embodiments, where instructions are communicated over a network by a user computing device, a structure network gateway are used to authenticate the transmitted of the instructions and may convert the communication protocol utilized by the user computing device to a communication protocol which may be utilized by the master control module. For example, a user computing device may transmit instructions under a first communication protocol to play music, turn on the fan, and turn on the lights all in a single instruction. The structure network gateway may convert the instructions from the first communication protocol to the second communication protocol which may be utilized by the master control module. The master control module may then utilize the instructions to change the state of any number of integrated structural devices in order to facilitate the instructions. For example, causing the audio control module to change the state of associated speakers from an off state to an on state, communicate the instructions to the air circulation control module to change the state of an associated fan from an off to an on state, and communicate the instructions to a lighting control module to turn a set of associated lights from an off state to an on state.

In additional or alternative embodiments, a user computing device may transmit instructions comprising a digital image which are utilized by the master control module to cause any number of changes to an associated lighting control component. For example, a user device may transmit a digital image of a smiling face comprised of black and yellow pixels in the shape of a circle with two eyes and an upward curved mouth to the master control module. The master control module may determine a pixel state for the image and an associated lighting dimension for a set of lights associated with the lighting control component. This pixel state including colors, brightness and pixel rows and columns may be utilized by the lighting control component to change the state of a set of lights having the lighting dimension to substantially match the color, brightness, and location of the pixels in the digital image. As such, the lights associated with the lighting control component would illuminate in a manner that substantially matches the digital image which displays a smiling face with yellow and black colors on the LED lights. Similarly, more complex images can be mapped from the coordinate system of pixels in a digital image to an addressable lighting array communicatively coupled to the lighting control component.

### BRIEF DESCRIPTION OF THE DRAWINGS

Aspects of the present disclosure are described in detail herein with reference to the attached Figures, which are intended to be example and non-limiting, wherein:

FIG. 1 depicts an example of a computer environment, in accordance with aspects described herein;

FIG. 2 depicts a diagram of a network environment, in accordance with aspects described herein;

FIG. 3 depicts an example gateway and control module, in accordance with aspects described herein;

FIG. 4 depicts an example control module, in accordance with aspects described herein;

FIG. 5 depicts an example lighting control modules, in accordance with aspects described herein;

FIG. 6 depicts an example air circulation control module, in accordance with aspects described herein;

FIG. 7 depicts an example audio control module, in accordance with aspects described herein;

FIG. 8 depicts an example temperature control module, in accordance with aspects described herein;

FIG. 9 depicts an example camera control module, in accordance with aspects described herein;

FIG. 10 depicts an example mechanical device control module, in accordance with aspects described herein;

FIG. 11 depicts an example scent control module, in accordance with aspects described herein; and

FIG. 12 depicts an example weather station module, in accordance with aspects described herein;

FIG. 13A-B depicts an example process for processing images and applying the processed images to assignable LEDs associated with the lighting control module;

FIG. 14 depicts an example structure and combination of modules, in accordance with aspects described herein;

FIG. 15 depicts a system flow schematic for communicating instructions to a lighting system, in accordance with one or more embodiments;

FIG. 16 depicts a flow chart of a method for communicating instructions to a plurality of integrated structural devices, in accordance with one or more embodiments; and

FIG. 17 depicts a flow chart of an additional or alternative method for communicating instructions to a lighting system in accordance with one or more embodiments.

### DETAILED DESCRIPTION

The present disclosure is directed to systems, devices, methods, processes, and computer readable media for the communication, control and manipulation of multiple features and device associated with a structure. In some embodiments, the structure may comprise a pergola, or any other outdoor structure. The structure may comprise at least one master control module which is configured to receive instructions from a user computing device that may be located at a close proximity, at a far distance, on a connected local network, or not connected by any network. The master control module may be associated with a structure network gateway configured to receive a request from the user computing device no matter the distance or network connections of both devices and irrespective of the communication protocol used by the structure network gateway, or any device used in the communication to, or from, the structure network gateway. The structure network gateway may be located at an independent server, an independent computer module, or may be a software or hardware component of the master control module. If the user computing device is located at a remote network, for example a cellular communication base station, the structure network gateway is configured to receive a request from the user computing device. Based on receiving the request, the structure network gateway may determine that the user computing device is associated with the server. Based on this determination, the server may transmit requests received from the user computing device, and translate the requests into a form that is recognizable by the gateway. For example, the server may convert the request from a communication protocol associated with the user computing device to a communication protocol associated with the structure network gateway. In some embodiments, the communication protocol associated with the user computing device corresponds to an application layer data communications (e.g., HTTP/HTTPS, Representational State Transfer (REST), WebSockets, Message Queuing Telemetry Transport (MQTT) and so forth). The communication protocol associated with the structure network gateway may be a scalable IPv6-based wireless networking protocol (e.g., Thread). Further, the communication protocol associated with the structure network gateway may include one or more application layer protocols (e.g., Matter).

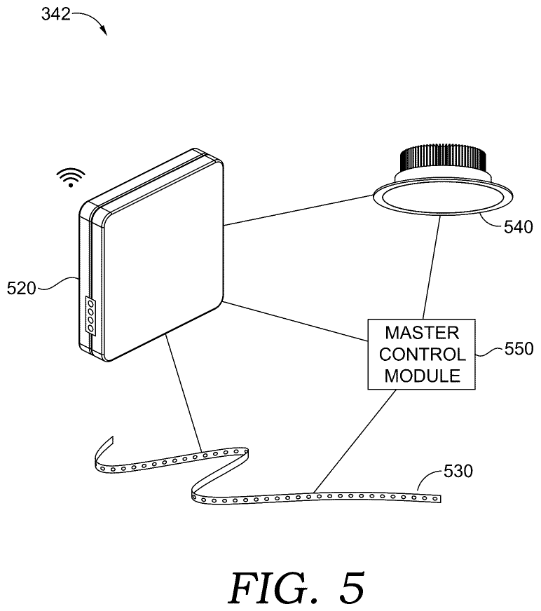

In this way, a user computing device with no direct connection with the structure network gateway, may still communicate with and transmit instructions to the structure network gateway and master control module. The instructions communicated to the structure network gateway may provide instructions to make any number of changes to the structure associated with the structure network gateway. The structure network gateway, either as an independent component or a component integrated into the master control module may transform the instructions from any communication protocol to a communication protocol usable by the master control module and may use the transformed instructions to make any number of changes to the structure. For example, the structure may have multiple wired or wireless communication devices related to a number of integrated structural devices of the structure, such as the integrated structural devices discussed in FIGS. 5-12. Such integrated structural devices may include a lighting control component, an audio control component, temperature control component, camera control component, mechanical devices associated with movement of portions of the structure, air circulation control components, scent control component or any other integrated structural device that may be communicated with by the master control module. A weather station may also be included which may record features of the environment related to the weather conditions. These weather conditions may be used in making changes with any integrated structural device associated with the master control module.

The instructions, once received by the gateway, may be transmitted to any of the communication devices associated with integrated structural devices. Additionally, a single set of instructions received by the structure network gateway may be configured to make changes to any number of the integrated structural devices. For example, the user computing device may transmit a single instruction to the structure network gateway. Upon receiving the instruction, the structure network gateway may convert the instructions from a first communication protocol to a second communication protocol and communicate instructions to the master control module. In additional or alternative embodiments, the structure network gateway is integrated into the master control module as a hardware or software component. The master control module may transmit the instructions to any number of integrated structural devices to cause a change in any number of the integrated structural devices. As such, any number of integrated structural devices may be caused to change state based on any number of received instructions.

By way of example a user associated with a user computing device may transmit data to the structure network gateway. This communication may be received by at a server associated with the structure network gateway or at the master control module with an integrated structure network gateway and it may be determined that the user computing device is associated with an identifier that indicates that it may communicate with the structure network gateway. The structure network gateway may also determine that the user computing device may connect with the structure network gateway, and based on determining this, the structure network gateway may allow transmissions from the user computing device to be received by the master control module. The transmission from the user computing device may be received in any format and with any number of associated identifiers. The format may be converted from a first format by the structure network gateway into a second format. This second format may be a format that allows the transmission to be communicated from the structure network gateway to the master control module and the integrated structural devices. This allows a user computing device, not communicatively connected to the structure network gateway and communicating under a first communication protocol, to communicate with the master control module irrespective of the master control module communication protocol. Additionally, each of the integrated structural devices associated with the structure, the master control module, and the structure network gateway may comprise nodes of a mesh network which are communicatively connected to each other node of the mesh network.

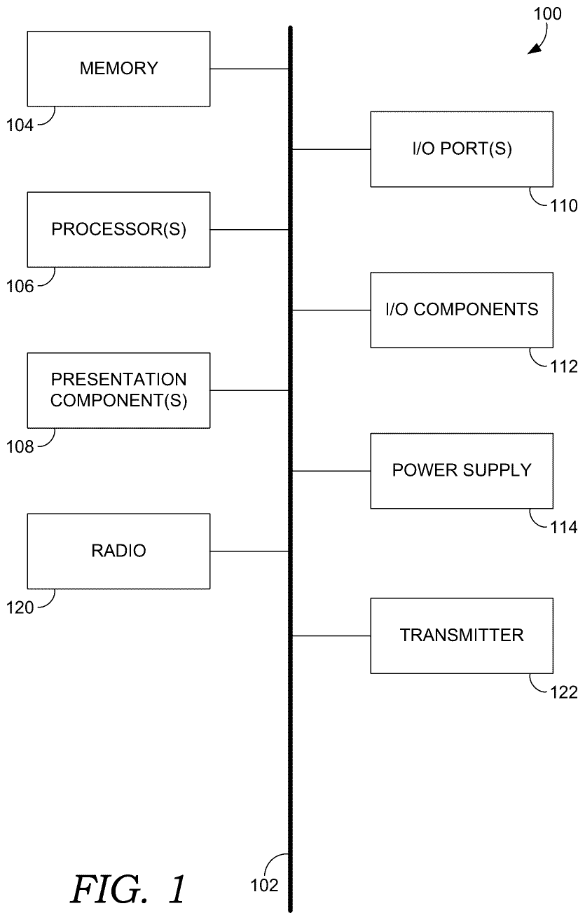

With reference to FIG. 1, computing device 100 includes bus 102, which directly or indirectly couples the following devices: memory 104, one or more processors 106, one or more presentation components 108, input/output (I/O) ports 110, input/output (I/O) components 112, and illustrative power supply 114. Bus 102 represents what may be one or more buses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 1 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 1 and with reference to “computing device.”

Computing device 100 typically includes a variety of computer-readable media. Computer-readable media can be any available media that can be accessed by computing device 500 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 100. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 104 includes computer storage media in the form of volatile or non-volatile memory. The memory may be removable, non-removable, or a combination thereof. Example hardware devices include solid-state memory, hard drives, optical-disc drives, etc. Computing device 100 includes one or more processors that read data from various entities, such as memory 104 or I/O components 112. Presentation component(s) 108 presents data indications to a user or other device. Example presentation components include a display device, speaker, printing component, vibrating component, etc.

I/O ports 110 allow computing device 100 to be logically coupled to other devices, including I/O components 112, some of which may be built-in. Illustrative components include a microphone, joystick, game pad, satellite dish, scanner, printer, wireless device, etc. The I/O components 112 may provide a natural user interface (NUI) that processes air gestures, voice, or other physiological inputs generated by a user. In some instances, inputs may be transmitted to an appropriate network element for further processing. A NUI may implement any combination of speech recognition, stylus recognition, facial recognition, biometric recognition, gesture recognition, both on screen and adjacent to the screen, as well as air gestures, head and eye tracking, or touch recognition associated with a display of computing device 100. Computing device 100 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 100 may be equipped with accelerometers or gyroscopes that enable detection of motion. The output of the accelerometers or gyroscopes may be provided to the display of computing device 500 to render immersive augmented reality or virtual reality.

A radio 120 represents radios that facilitate communication with one or more wireless networks using one or more wireless links. In aspects, the radio 120 utilizes a transmitter 122 to communicate with a wireless network on a first wireless link. Though one radio is shown, it is expressly conceived that a computing device with multiple radios could facilitate communication over one or more wireless links with one or more wireless networks via multiple radios and transmitters. Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, 6G, VOLTE, or other VOIP communications. In some embodiments, the radio 120 is configured for communicating using one or more protocols, and may be configured to communicate on distinct frequencies or frequency bands (e.g., as part of a carrier aggregation scheme). As can be appreciated, in various embodiments, the radio 120 can be configured to support multiple technologies and/or multiple frequencies.

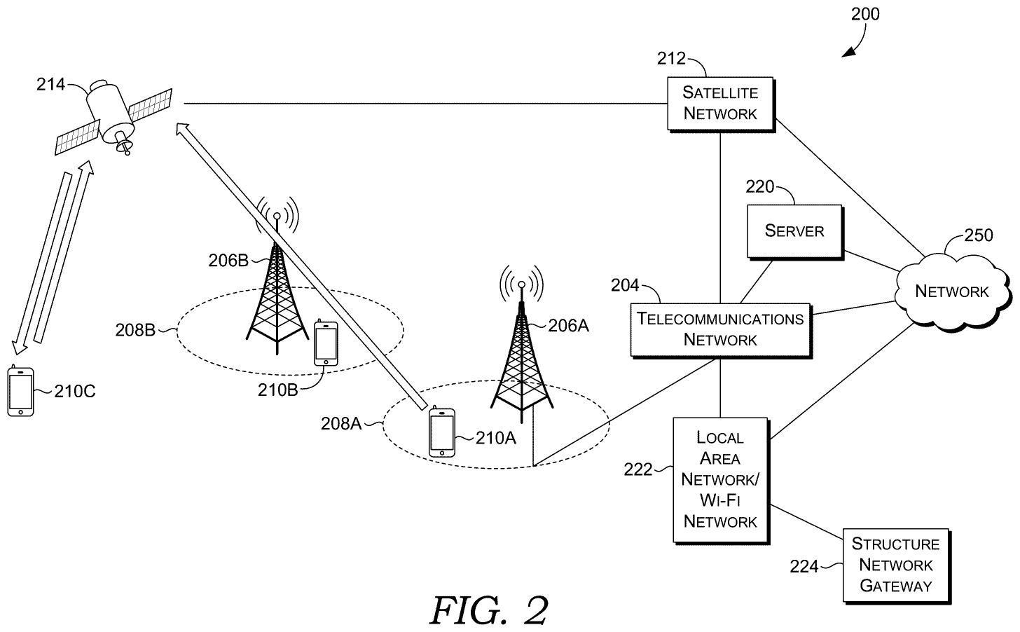

Referring to FIG. 2, an example network environment 200 depicted, in accordance to aspects described herein. Example network environment 200 includes telecommunication network 204, telecommunication base stations 206A and 206B, base station ranges 208A and 208B, user computing devices 210A-210C, satellite network 212, satellite 214, local area network/Wi-Fi network, server 220, network 250, and structure network gateway 224. This is one example network environment 200 which may facilitate communication between a user computing device such as user computing devices 210A-210C and the structure network gateway 224. As such, FIG. 2 represents an example method of communication. Other configurations of suitable network environments are not directly shown in FIG. 2 but may also be applicable. For example, FIG. 2 illustrates communication between the user computing devices 210A-210C and the satellite 214 which transmits information to the satellite network 212, then to the telecommunications network. In additional or alternative embodiments, the satellite 214 may facilitate communication directly with a local area network/Wi-Fi Network 222 or directly with the structure network gateway 224. The structure network gateway 224 may receive transmissions from any number of user computing devices such as user computing devices 210A-210C in FIG. 2. Additionally or alternatively, each of the satellite network 212, server 202, telecommunication network, and local area network/Wi-Fi network may be connected to a general network which may facilitate communication between each of these devices.

In some embodiments, a user computing device, such as user computing devices 210A-210C communicates directly with a local area network/Wi-Fi network which may facilitate communication with the structure network gateway 224. In some embodiments, the user computing devices 210A-210C communicates directly with the structure network gateway 224, or the user computing devices 210A-210C may communication with the network 250 in order to transmit instructions and data packets to the structured network gateway 224. As such, any method of communication between a user computing device 210A-210C and the structure network gateway 224 may be utilized. In some embodiments, the telecommunication network 204 is any telecommunication network capable of facilitating the transmitting of data between computing devices. In additional or alternative embodiments, such a telecommunication network 204 may be capable of transmitting data over any wireless communication protocol such as 5G or LTE. The telecommunication network 204 may receive facilitate communications between the user computing devices 210A-210C and the structure network gateway 224, this may be through the utilization of a local area network/Wi-Fi network 222 or the telecommunication network 204 may facilitate communications directly with the telecommunications.

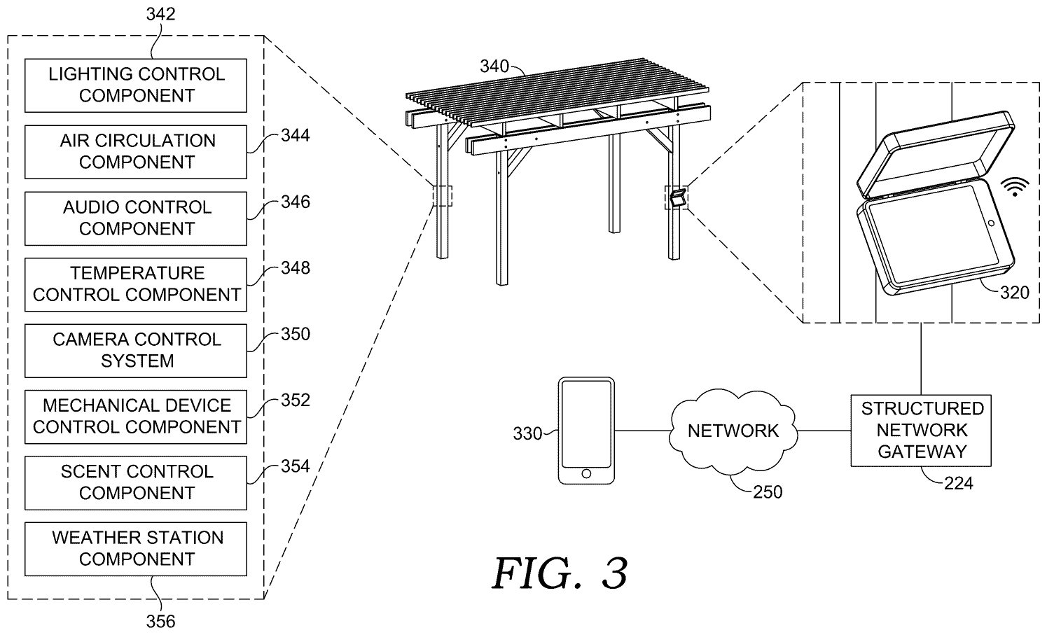

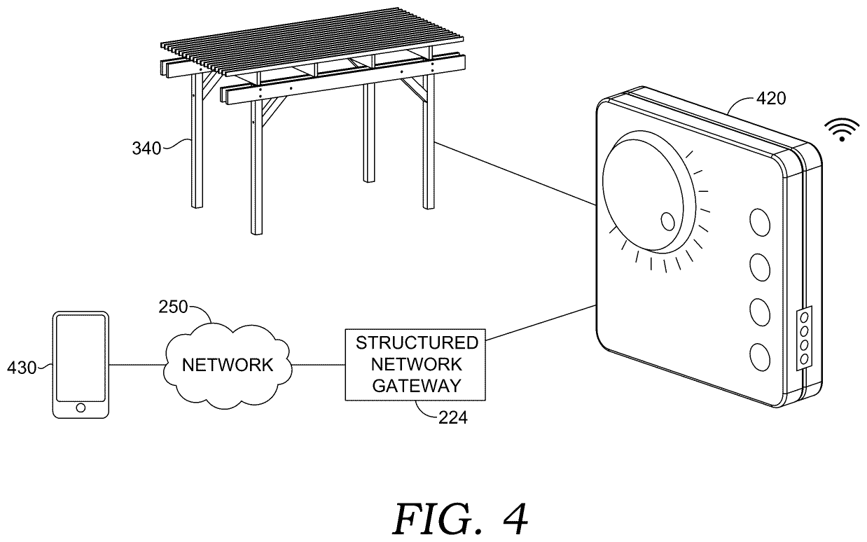

Referring to FIG. 3, an example touch screen master control module 320 is shown including a device with touchscreens which may be used to make changes to an associated structure such as structure 340 through communications with any number of integrated structural devices such as devices 342-356. In some embodiments, the touch screen master control module 320 is one example of a master control module, an additional or alternative example is the tactile master control module 420 discussed in FIG. 4 which utilizes selectable buttons and dial. But, as used throughout, master control module may be used interchangeably with touch screen master control module 320, and tactile master control module 420.

As discussed in relation to FIG. 2, the structure network gateway 224 may be software, hardware, firmware, or a combination thereof. In some embodiments, the structure network gateway 224 is incorporated into the master control module, associated with a server such as server 220, may be an independent computer module distinct from server 220, or the control module such as the touch screen master control module 320. The touch screen master control module 320 may comprise a screen which may display a graphical user interface. The screen may be configured as a touch screen capable of receiving direct inputs by a user. The screen may also be associated with any number of hardware devices which when interacted with by a user, causes changes in the graphical user interface and the functioning of the master control module. For example, a user may interact with a touch screen which causes display of or a change to a graphical user interface. The user may then interact with any number of selectable graphical user interface elements which when selected may cause changes in the graphical user interface and changes in the integrated structural devices associated with the master control module. For example, the graphical user interface associated with the master control module may display a first selectable element with the text “moods.” By selecting this first selectable element, the master control module may cause a change in the graphical user interface which results in the display of at least a second selectable element. In examples, this second selectable element may include text such as “relaxed,” “party,” “date,” and so on. In additional or alternative embodiments, a user computing device 330 may transmit instructions through the network 250 to the structure network gateway 224 and the touch screen master control module 320. In additional or alternative embodiments, the user computing device 330 may transmit instructions directly to the master control module such as the touch screen master control module 320 wherein the structure network gateway 224 is incorporated into the master control module, or may first transmit instructions to the structure network gateway 224 wherein the structure network gateway 224 is associated with a server or independent computer module distinct from server 220. In some embodiments, the master control module, such as the touch screen master control module 320 may be in communication with any number of systems of integrated structural devices, for example a lighting control component 342, an air circulation system 344, an audio control component 346, a temperature control component 348, a camera control component 350, a mechanical device control component 352, a scent control component 354, or a weather station system 356. The systems will be discussed in more detail below. Each of these systems may be in communication with the master control module, such as the touch screen master control module 320 and may be electronically or mechanically connected to the touch screen master control module 320 such as through a wired connection. Each integrated structural device may be associated with a control module such as the air circulation control module 620 Additionally, or alternatively, they may be connected via a local area network/Wi-Fi network such as the local area network/Wi-Fi network 222 discussed in relation to FIG. 2.

In some embodiments, the control modules associated with each integrated structural device may be software or hardware included within or as a part of the master control module, may be associated with a server such as server such as server 220, or may be a computer module distinct from the master control module. The master control module may be configured to make any change to the state of an integrated structural device. The changes of state may comprise mechanical changes or electronic changes such as causing the activation of mechanical pistons or motors, or the activation of hardware or software associated with integrated structural devices. For example, the master control module may change the state of an integrated device from one binary state to a second binary state, such as turning an integrated structural device on or off. In additional or alternative embodiments, the master control module may be configured to change the state of an integrated structural device from one gradient to a second gradient, for example adjusting a temperature of a heater by any number of degrees, or increasing or decreasing a fan speed by a variable amount.

By way of example, based on receiving a selection of a selectable element on the touch screen control module 320, the master control module may cause changes in the integrated structural devices associated with the structure. For example, the user may select a selectable element which includes the text “relaxed.” This may cause the master control module to transmit instructions to the air circulation system 344 to decrease the speed of at least one fan associated with the air circulation system 344. The same selection may also cause the master control module to transmit instructions to the lighting control component 342 to dim at least one light, such as a light emitting diode (LED) associated with the lighting control component 342. Further, this same selection may cause a change in the audio control component 346 associated with the master control module. For example, this may cause at least one speaker associated with the audio control component 346 to reduce volume. Any number of changes may be caused to any number of integrated structural devices based on the selection of a single selectable element or based on receiving any number of instructions from a user computing device 330. Referring to FIG. 4, an example tactile master control module 420 is shown including selectable buttons labeled A-D along with an adjustable dial and wireless connection capabilities. In some embodiments, this tactile master control module 420 may be utilized in addition to or in the place of the touch screen master control module 320. The tactile master control module 420 may comprise any number of buttons, dials or screens that allow for a user to directly interact with the device in order to change the state of any number of integrated devices.

Referring to FIG. 5, an example lighting control component 342 is depicted. In some embodiments, the lighting control component 342 may comprise a lighting control module 520, having wireless and wired connection capabilities and associated adjustable and addressable LED downlights 540 and adjustable and addressable LED strip lights 530 which may receive instructions from the lighting control module 520. The lighting control module 520 may be communicatively connected to the master control module 320/430 such as the touch screen master control module 320 or tactile master control module 420. In additional or alternative embodiments, the lighting control module 520 may be a part of the master control module such as a software or hardware component.

In some embodiments, the structural network gateway, master control module 550 and the lighting control module 520 may be configured to receive digital images. As discussed herein, the structural network gateway and lighting control module 520 may be hardware or software components incorporated into the master control module 550. Master control module 550 may configured to receive instructions and issue commands to communicatively coupled integrated structural devices. For example, in some embodiments master control module 550 may be master control module 320 of FIG. 3 or master control module 420 of FIG. 4. The digital images may be received from a user computing device such as the computing devices discussed above. In some embodiments, the master control module 550, structural network gateway, and lighting control module 520 may be configured to store digital images, or receive them from any other source such as a connection to the internet. The structural network gateway, master control module 550, and lighting control module 520 may also be configured to determine the number and configuration of pixels associated with the digital image. These may also be capable of reducing the file size of a received digital image through compression, or may adjust the number of pixels associated with the image such as in downsampling or upsampling the image. Compression may comprise removing bytes of information from the image to reduce pixel quantity, or may remove any other data associated with the image in order to save storage capacity. Additionally, the images may be downsampled in order to reduce the pixel count associated with the image. The master control module 550, structural network gateway, and lighting control module 520 may use any downsampling algorithm to accomplish the reduction in pixel count such as the mipmap algorithm, box sampling algorithm, or sinc-based image resampling by way of example.

The images received by the master control module 550, structural network gateway, and lighting control module 520 may be processed such that information related to the image may be available to the master control module 550, structural network gateway, and lighting control module 520. The information gained through processing the images may comprise at least the pixel number, pixel length, and pixel width of the image and a pixel state which may be comprised of the pixel number, pixel length, and pixel width. The pixel state may further comprise data related to the Red, Green, Blue (RGB) value or brightness of each pixel within the pixel state. Each pixel state may be associated with at least a hue, a saturation, or a brightness. A hue may refer to the color aspect of light and corresponds to the wavelength of the light. As such this may be represented by a color or color value such as an RGB value for example R:240, G:255, B:255 for azure or R:255, G:215 B:0 for gold. The numeric value for the hue which may be transmitted to control modules and control components may be represented by a hue value. A saturation may define the chroma, intensity, purity, or vividness of a color. A high saturation makes a color more vivid or intense. A low saturation identifies a color as having low saturation or a more washed-out or grayish appearance. The numeric value for the saturation which may be transmitted to control modules and control components may be represented by a saturation value. A brightness as used herein refers to a value of lightness and indicates how light or dark a color appears. This may also indicate the amount of luminance or measurable amount of light which is emitted from a pixel or light. The numeric value for the brightness which may be transmitted to control modules and control components may be represented by a brightness value. These images may be used for a multitude of purposes. For example, the master control module 550, structural network gateway, and lighting control module 520 may use the received images to make changes to the lighting control component 342 associated with the structure. This lighting control component 342 may be associated with a number of assignable and configurable light emitting diodes (LEDs) such as the addressable LED downlights 540 and adjustable and addressable LED strip lights 530. The master control module 550 may determine a pixel length and width of the received image and based on this determination transmit instructions related to this information to the lighting control component 342. For example, the master control module 550 may determine that there are 20 vertically aligned LEDs associated with the lighting control component 342. Additionally, it may be determined that the pixel state of the received image is comprised of a pixel length 20 pixels and a pixel width of 3 pixels. Therefore, the image is made up of 3 vertical columns of 20 pixels each, and 20 horizontal rows of 3 pixels each, making the entire image a total of 60 pixels. The master control module 550 may transmit instructions to the lighting control component 342 related to the positioning of the pixels in the image. For example, the master control module 550 may transmit instructions to the lighting control component 342 to cause the 20 LEDs to change the RGB value or brightness based on a corresponding pixel in the image. In additional or alternative embodiments, the master control module 550 may transmit instructions that cause the top most LED of the 20 LEDs to change color to substantially match the color of the corresponding top left most pixel in the image.

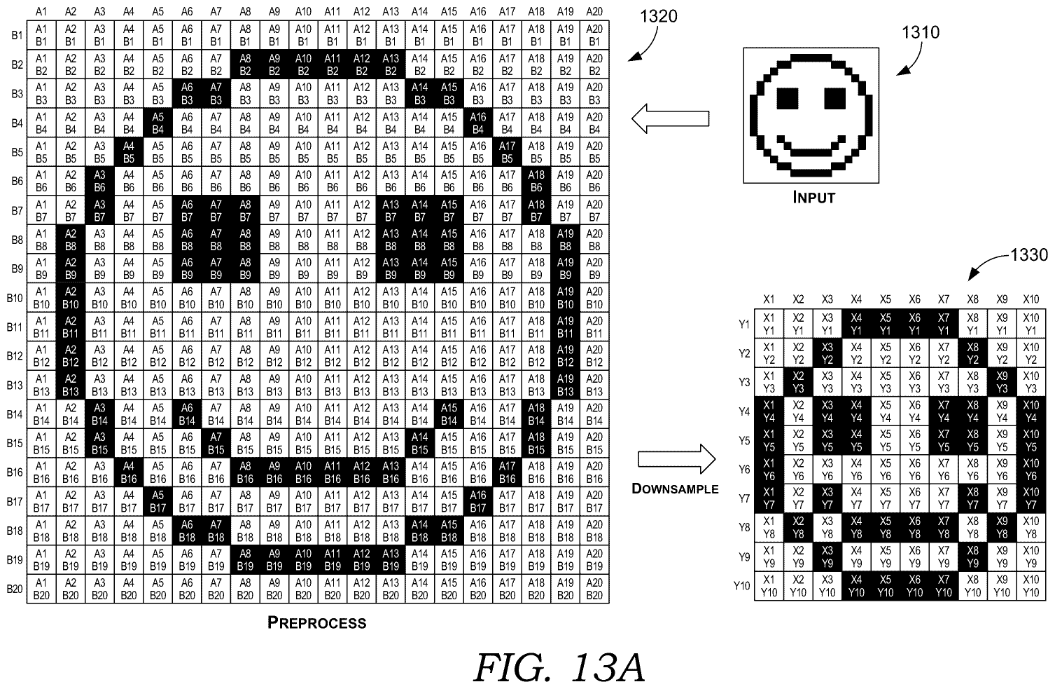

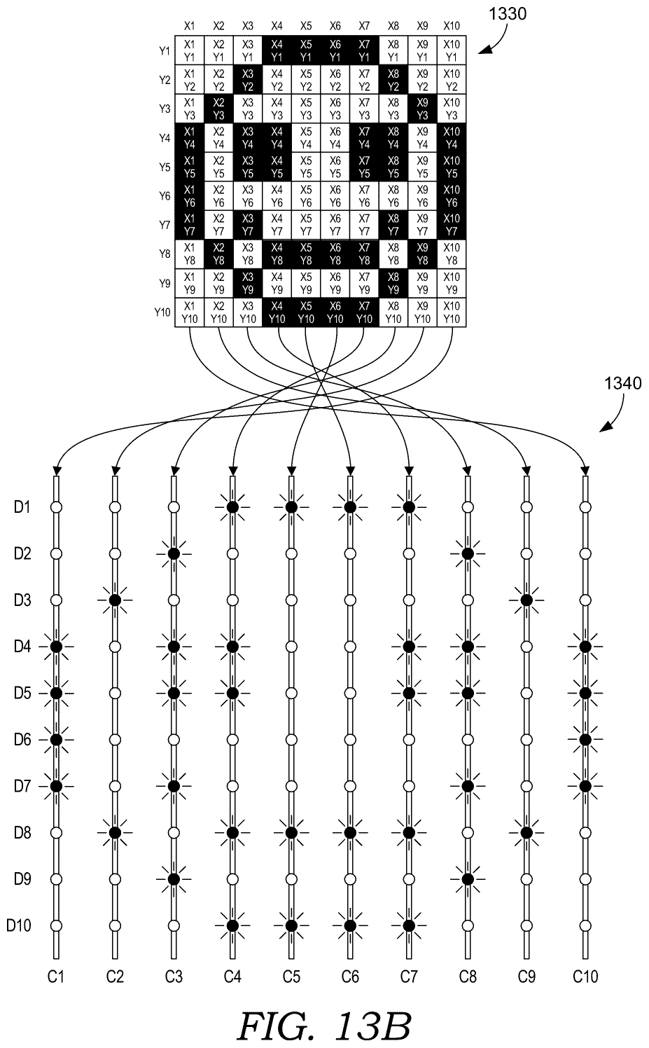

This instruction may further comprise instructions to cause each of the 20 LEDs to change to substantially match the color or brightness of each of the 20 pixels in the first vertical column of the image, meaning the first LED substantially matches the first pixel in the first column, the second LED substantially matches the second pixel in the first column, and so on for the 20 pixels of the first column. As such, the 20 LEDs will substantially match the 20 pixels of the first column of the image. Further instructions may be transmitted that cause the 20 LEDs to change to match subsequent columns of the image, such that the 20 LEDs substantially match the 20 pixels in the first column of the image and then after a predetermined amount of time, the 20 LEDs are instructed to match the 20 pixels in the second column of the image, and after a second predetermined amount of time, the 20 LEDs are instructed to match the 20 pixels in the third column of the image. By way of example the transmitted digital image could be a sunset or a smiling face. The pixel states of the digital image may be determined and utilized by the master control module to instruct the lighting control component 342 to cause associated lights to change state to substantially match the digital image. For example, the associated lights may change color and brightness to show the likeness or exact image of the smiling face or the likeness or exact image of the sunset. This process is discussed in more detail in relation with FIGS. 13A-13B below.

It is to be understood that any number of pixels may be associated with received images and any number of LEDs may be associated with the lighting control component 342. As such, the master control module 550 may transmit instructions to the lighting control component 342 to cause a change in any number of LEDs to cause any number of LEDs to substantially match any number of pixels associated with the received image. In some embodiments, substantially match may comprise matching the RGB value and/or brightness of each pixel to each individual LED. In additional or alternative embodiments, substantially match may comprise matching the RGB value and/or brightness of a set of downsampled pixels to an associated number of LEDs. In some embodiments where an image includes more pixels than there are LEDs, the master control module 550 may conduct downsampling of the image. This may allow the master control module 550 to transmit information to a set of LEDs that are less in number than vertical or horizontal pixels of an image. For example, the master control module 550 may use any downsampling algorithm to combine rows or columns or any number of pixels in the image such that simplified information related to the pixels may be transmitted to the LEDs. This may allow an image with a vertical pixel length of 40 and horizontal pixel width of 6 to be converted into a format that may be used to transmit a set of instructions to a set of 20 LEDs. The master control module 550 may conduct downsampling such that each quadrant of 4 pixels is reduced to 2. Any form of downsampling may be used to transmit information for an image with any number of pixels to a lighting control component 342 with any number of LEDs. Additionally, lighting instructions along with timing instructions may be transmitted to the lighting control component 342 such that the resulting lights generated by the LEDs appear to change and move along the image as the image information is transmitted to the lighting control component 342. Further, the structure may be associated with an audio control component 346 associated with any number of speakers. The master control module 550 may also be configured to receive audio data. The audio data may be musical audio or audio associated with nature or any other form of audio data. The master control module 550 may transmit instructions to the audio control component 346 to cause any of the associated speakers to play audio received by the master control module 550. In additional embodiments, the master control module 550 may also transmit instructions associated with both the audio control component 346 and lighting control component 342. These instructions may cause the lighting control component 342 to brighten and dim LEDs associated with the audio control component 346 at times which correspond to beats or swells of the audio played by the speakers associated with the audio control component 346.

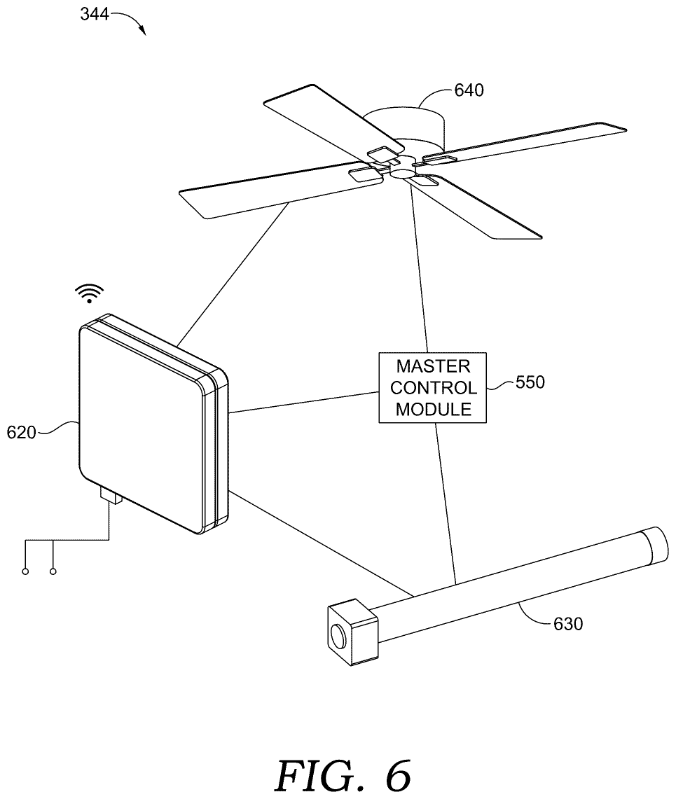

Referring to FIG. 6, an example air circulation system 344 is depicted. In some embodiments, the air circulation system 344 may comprise an air circulation control module 620 is shown including at least a ceiling fan 640, an AC tubular motor 630. The air circulation control module 620 may have wired and/or wireless communication capabilities for controlling and air circulation via integrated structural devices such as a ceiling fan 640 and AC tubular motor 630. Each of the air circulation control module 620, ceiling fan 640, and AC tubular motor 630 may be communicatively connected to the master control module 550 such as the touch screen master control module 320 or tactile master control module 420. In additional or alternative embodiments, the air circulation control module 620 may be software or hardware included within or as a part of the master control module. A user computing device may transmit instructions to the master control module 550 and based on receiving the instructions, the master control module 550 may transmit the instructions to the air circulation control module 620, or may utilize the air circulation control module 620 to change the state of integrated structural devices such as the ceiling fan 640 or AC tubular motor 630. For example, a user may transmit instructions from a user device which are converted from a first communication protocol to a second communication protocol by the structured network gateway 224. The data of the transmitted instructions may be utilized to cause the ceiling fan 640 to increase or decrease speed, or to turn on or off.

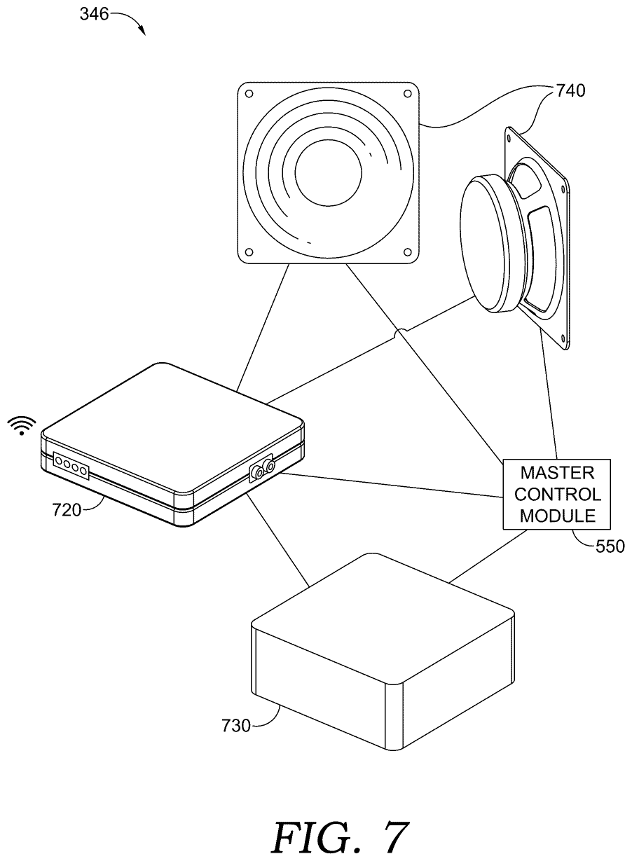

Referring to FIG. 7, an example audio control component 346 is depicted. In some embodiments, the audio control component 346 may comprise an audio control module 720 is shown including wired and wireless communication capabilities along with an amplifier 730 and speakers 740 for outputting audio. Each of the audio control module 720, speakers 740, and amplifier 730 may be communicatively connected to the master control module 550. In some embodiments, each of the audio control module 720, speakers 740, and subwoofer 730. In some embodiments, the audio control module 720 is integrated into the master control module 550 as hardware or software components. In some embodiments, master control module 550 may transmit instructions to the audio control module 720 or utilize the audio control module 720 to change the state of any integrated structural devices associated with the audio control module 720 such as the speakers 740, and subwoofer 730. A user may input commands directly into a touch screen of the master control module 550, or may transmit instructions to the master control module 550 in order to change the state of the integrated structural devices. For example, a user may transmit instructions to the master control module 550 to change from a first song to a second song, or may transmit instructions to increase or decrease the music. The master control module 550 may transmit the instructions to the audio control module 720 or utilize the audio control module 720 to change the state of the integrated structural devices to implement these instructions.

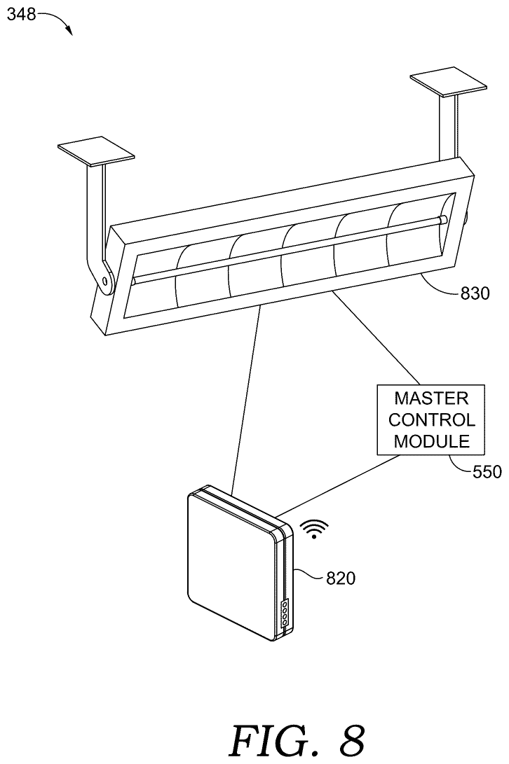

Referring to FIG. 8, an example temperature control component 348 is depicted. In some embodiments, the temperature control component 348 may comprise a temperature control module 820 with wired and wireless communication capabilities and an electric radiant heater 830. Each of the temperature control module 820 and heater 830 may be communicatively connected to the master control module 550. In some embodiments, the temperature control module 820 may be software or hardware integrated into the master control module 550. Based on receiving instructions either from a user device or from interaction with the master control module 550 the master control module 550 may transmit instructions to the temperature control module 820, or may utilize the temperature control module 820 to change the state of integrated structural devices such as the heater 830. For example, a user computing device may transmit instructions to master control module to increase or decrease the temperature of the heater 830, or turn the heater 830 on or off. The master control module 550 may transmit the instructions to the temperature control module 820 or utilize the audio control module 820 to change the state of the integrated structural devices to implement these instructions.

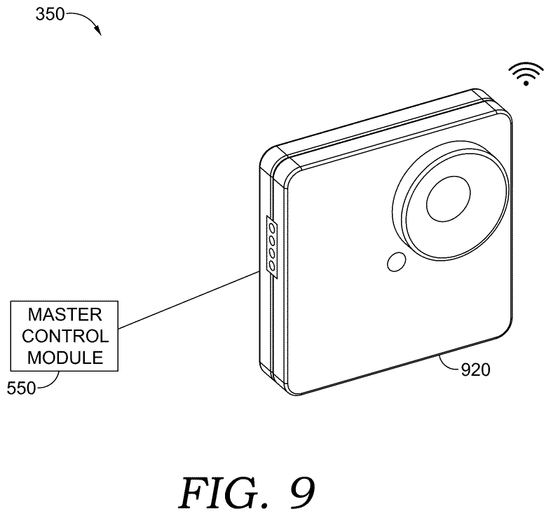

Referring to FIG. 9, an example camera control component 350 is depicted. In some embodiments, the camera control component 350 may comprise a camera control module 920 having wired and wired communication capabilities and an occupancy sensor. The camera control module 920, may be communicatively connected to the master control module 550 and additionally or alternatively may be connected to any number of cameras either housed on the camera control module 920 or communicatively connected to the camera control module 920. In some embodiments, the camera control module 920 may be integrated into the master control module 550 as hardware or software components. Based on receiving instructions from a user computing device or from interaction with the master control module 550, the master control module 550 may communicate the instructions to the camera control module 920 or utilize the camera control module to change the state of associated integrated structural devices. For example, a user computing device may transmit instructions to master control module to capture an image utilizing an associated camera, or turn an associated camera on or off. The master control module 550 may transmit the instructions to the camera control module 920 or utilize the camera control module 920 to change the state of the integrated structural devices to implement these instructions.

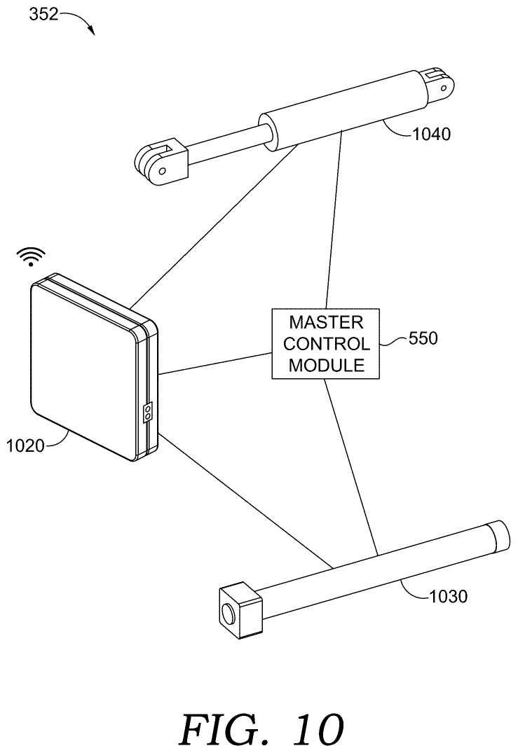

Referring to FIG. 10, an example mechanical device control component 352 is depicted. In some embodiments, the mechanical device control component 352 may comprise a mechanical device control module 1020 having wired and wireless communication capabilities, a linear actuator 1040, and a tubular motor 1030 that may be used to manipulate shades. Each of the mechanical device control module 1020, linear actuators 1040, and tubular motor 1030 may be communicatively connected to the master control module 550. In some embodiments, the mechanical device control module 1020 may be software or hardware integrated into the master control module 550. Based on receiving instructions either from a user device or from interaction with the master control module 550 the master control module 550 may transmit instructions to the mechanical device control module 1020, or may utilize the mechanical device control module 1020 to change the state of integrated structural devices such as the linear actuators 1040, and tubular motor 1030. For example, a user computing device may transmit instructions to master control module to extend a shade by a certain percentage degree or completely withdraw a portion of the structure through the adjustment of the associated linear actuators 1040 or tubular motor 1030. The master control module 550 may transmit the instructions to the mechanical device control module 1020 or utilize the mechanical device control module 1020 to change the state of the integrated structural devices to implement these instructions.

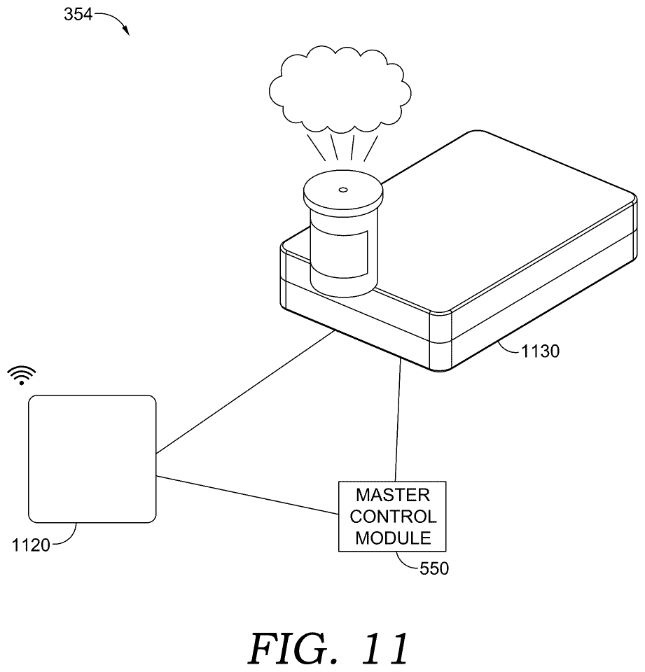

Referring to FIG. 11, an example scent control component 354 is depicted. In some embodiments, the scent control component 354 may comprise a scent control module 1120 having wired and wireless communication capabilities along with a scent dispersal mechanism 1130. Each of the scent control module 1120, and scent dispersal mechanism 1130 may be communicatively connected to the master control module 550. In some embodiments, the scent control module 1120 may be software or hardware integrated into the master control module 550. Based on receiving instructions either from a user device or from interaction with the master control module 550 the master control module 550 may transmit instructions to the scent control module 1120, or may utilize the scent control module 1120 to change the state of integrated structural devices such as the heater 830. For example, a user computing device may transmit instructions to master control module to activate or deactivate a scent by the scent dispersal mechanism or to increase or decrease the dispersing of a scent by the scent dispersal mechanism 1130. The master control module 550 may transmit the instructions to the scent control module 1120 or utilize the scent control module 1120 to change the state of the integrated structural devices to implement these instructions.

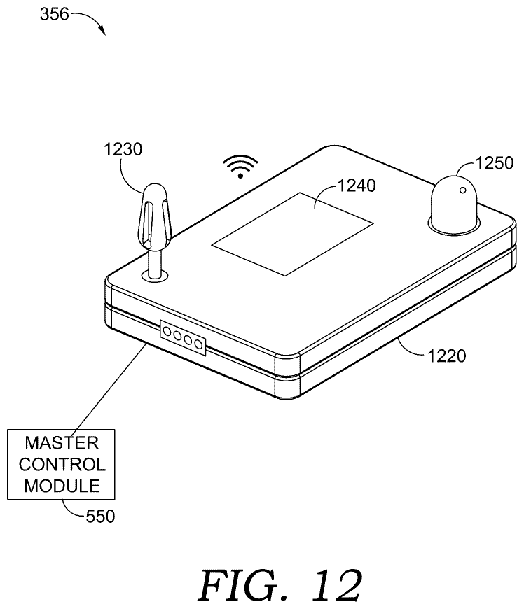

Referring to FIG. 12, an example weather station system 356 is depicted. In some embodiments, the weather station system 356 may comprise a weather station module 1220 which may include a wind speed sensor 1230, a temperature sensor 1240, and a rain sensor 1250 and wired and wireless communication capabilities. Each of the weather station module 1220, temperature sensor 1240 and rain sensor 1250 may be communicatively connected to the master control module 550. In some embodiments, the weather station module 1220 may be software or hardware integrated into the master control module 550. Based on receiving instructions either from a user device or from interaction with the master control module 550 the master control module 550 may transmit instructions to the heat control module 820, or may utilize the weather station module 1220 to change the state of integrated structural devices such as the heater 830. For example, a user computing device may transmit instructions to master control module to request information from any number of sensors associated with the weather station module 1220. The master control module 550 may transmit the instructions to the weather station module 1220 or utilize the weather station module 1220 to transmit the requested information.

Referring to FIGS. 13A-13B, an example process for processing images and applying the processed images to assignable LEDs associated with the lighting control module is shown. In some embodiments, an input image 1310 is received. For example, as shown in FIGS. 13A-13B, the image could be of a smiling face. This input image 1310 can be received by the control module, gateway, or a user computing device associated with the control module or gateway. Each of the control module, gateway, or use device may have an associated image processing system. The input image 1310 may also be received from any source such as a USB device, or the internet. Once the input image 1310 is received, the input image 1310 undergoes preprocessing as demonstrated in FIG. 13A at the preprocessed image 1320. In preprocessing, information is extracted from the input image 1310. Such information may comprise dimensions of the input image 1310, resolution of the input image 1310, width and length of the input image 1310, or the pixel count of the input image 1310. Following generation of the preprocessed image 1320, the input image 1310 is downsampled to downsampled image 1330. As discussed above, a received image may be downsampled using algorithms such as mipmapping, box sampling, or sinc-based image resampling by way of example. The above discussed image processing systems may conduct the downsampling and image processing discussed herewith. By way of explanation, FIG. 13A demonstrates a form of downsampling which may be used. Information that is extracted from input image 1310 is used to generate the preprocessed image 1320. FIG. 13A displays squares over the image. These squares are representative of pixels associated with input image 1310 which has been preprocessed.

In some embodiments, the pixels, as illustrated in FIG. 13A may be combined in order to generate a downsampled image 1330. By way of example, the pixels of the preprocessed image 1320 are broken down to columns of A1-Ax and row of B1-Bx. Returning to the embodiment discussed above, pixels A1B1, A2B1, A1B2, and A2B2 may be combined in order to generate pixel X1Y1 of the downsampled image 1330. Similar to the preprocessed image 1320, the pixels of downsampled image 1330 are broken down into columns of X1-Xx and rows of Y1-Yx. Returning to the embodiment discussed above, any number of pixels of the preprocessed image 1320 may be combined into any number of pixels in the downsampled image 1330. In the example above, four pixels from the preprocessed image 1320 are used to generate one pixel of the downsampled image 1330. As such, the resulting downsampled image 1330 is of a lower pixel count smiling face. This does not necessarily result in a smaller image as shown in FIG. 13A. Instead the downsampled image 1330 is used to illustrate the reduction in pixel count and the combining of the color values in the pixels which are combined into a single resultant downsampled image 1330. The downsampled image 1330 may be of the same size, increased size, or smaller size of the preprocessed image 1320. In some embodiments, this combination is accomplished by analyzing each of the four pixels to determine a color value for each individual pixel. A median or average color value for all four pixels are determined based on the color values of each individual pixel. In some embodiments, the average color value of the four pixels are then assigned to an associated pixel of the downsampled image 1330. The examples provided in FIGS. 13A-13B are shown in black and white to illustrate the combination and reduction of pixels. But the pixels of all images may be in any color, and the resultant combination of color values may result in any number of colors. Additionally, the pixels chosen to be combined may be in any combination, and do not need to be adjacent to one another. Further, the processed image may be downsampled to generate downsampled image 1330, and the downsampled image 1330 may be further processed to further downsample again to further reduce the pixel count and further combine the color values of associated pixels of downsampled image 1330.

Moving to FIG. 13B, the downsampled image 1330 may be used to generate a set of color patterns that are associated with an assignable LED strips 1340. The assignable LED strips 1340 may be associated with a lighting system such as the lighting system discussed herewith. The assignable LED strips 1340 may also be associated with any number of assignable LEDs. The assignable LEDs of the assignable LED strip 1340 may be organize into columns C1-Cx and rows D1-Dx. There may be any number of LEDs in each row and column of the assignable LED strips 1340. The colors of patterns may also transmitted to the assignable LED strips 1340 such that the pixels in downsampled image 1330 are displayed on associated LEDs C1-Cx and D1-Dx. In some embodiments, LED CID1 May be assigned the color value of pixel X1Y1 of the downsampled image 1330. Further, LED CID2 may be assigned the color value of pixel X1Y2. This assignment of color values based on the downsampled image color values may be used to cause the associated LED to emit light of the same or similar value to the associated pixel in the downsampled image. By way of example, FIG. 13B illustrates the assignable LED strips 1340 as emitting either white or black light in the shape of the downsampled image 1330 in the form of a smiling face. In some embodiments, these colors can be any color value which may be displayed by the LED lights of the assignable LED strips 1340. Additionally, in further embodiments, the colors black or white in the downsampled image 1330 may cause the LEDs of the assignable LED strips 1340 to either be turned on or off such that only certain lights which correspond to certain colors are emitting light. This may be repeated for each pixel of column X and row Y and each LED of column C and row D of the assignable LED strips 1340. In an embodiment in which there are the same number of pixels in the downsampled image 1330 as in there are LEDs of the assignable LED strips 1340, the downsampled image 1330 may be identical to or substantially similar to the image displayed by the assignable LED strips 1340. For example, if the downsampled image 1330 is of a sunset, an individual viewing the assignable LED strips 1340 may perceive a sunset.

In some embodiments, the LEDs of the assignable LED strips 1340 may be capable of emitting any color associated with the downsampled image. In additional embodiments, the LEDs of the assignable LED strips 1340 may have a limited color spectrum at which they may emit light. In some embodiments that the pixel of the downsampled image 1330 is of a color that cannot be emitted by the associated LED of the assignable LED strip, the associated LED of the assignable LED strip may emit the closest color value to the color value of the associated pixel of the downsampled image 1330 that it is capable of emitting. In some embodiments, the color value assigned to the LED may be associated with either the color white and black based on the color value of the pixel of the downsampled image 1330. For example, if the color associated with the pixel of the downsampled image 1330 is below a certain threshold, the color white may be assigned to the associated LED. As an additional example, if the color associated with the pixel of the downsampled image 1330 is above a certain threshold, the color black may be assigned to the associated LED.

Any number of pixels from the downsampled image 1330 may be assigned to any number of the LEDs of assignable LED strips 1340. By way of example, each pixel of row Y of the downsampled image 1330 may be assigned to a corresponding LED of row D. For example Y1 assigned to D1 and Y2 to D2 and so on. If there are less LEDs in row D than there are pixels in row Y, the values of the pixels in row Y may be averaged such that they may be assigned to the LEDs of row D. By way of example, if there are 20 pixels in row Y, and 10 LEDs in row D, the pixels of row Y may be averaged such that the pixel color values are combined into 10 color values which may be assigned to and displayed by the 10 LEDs of row D. The color values of these pixels may be combined in any manner, such as the color values of pixel 1 and 2 of row Y being combined into an averaged color value that is then associated with the first LED of row D. This may be repeated for each column of columns C and X.

In further embodiments, there may be fewer columns of LEDs in the assignable LED strips 1340 than there are columns of pixels in the downsampled image 1330. In such embodiments, the time at which the LEDs of the assignable LED strips 1340 may be adjusted. The pixels of the downsampled image 1330 may be assigned to LEDs of the assignable LED strips 1340 such that the LEDs of the assignable LED strips show portions of the downsampled image 1330 starting with the pixels on the left and over time displaying each column until the full downsampled image has been displayed by the assignable LED strips 1340. For example, the downsampled image 1330 may be of a sunset with 20 columns of pixels. The assignable LED strips 1340 may only contain 2 columns of LEDs. The color information for the pixels of the sunset may be associated with and displayed by the 2 columns of the LED such that over time the entire sunset image is displayed. For example, the LEDs may change after a predetermined set of time, by way of example 2 seconds. In the first 2 seconds, the first and second columns of the sunset image is displayed by the 2 columns of LEDs. After 2 seconds, the third and fourth columns of the sunset image may be displayed by the 2 columns of LEDs. This may be continued every 2 seconds until each of the 20 columns of the sunset image have been displayed by the LEDs. As such, the pixels of the downsampled image 1330 may be associated with and displayed by the assignable LED strips 1340 such that the assignable LED strips 1340 may appear to be panning through the image. This timed display may be accomplished with any number of pixels, any number of assignable LEDs and may use any time interval. For example, with a sufficient amount of time, assignable LEDs and time intervals, the assignable LED strips 1340 may display a passing cloud or a sunrise to sunset, or a music video. The assignable LED strips 1340 may also be communicatively connected to the audio system. In some embodiments, the audio system and assignable LED strips 1340 which are associated with the lighting system such that the control module may be used to play audio and lighting which are associated within the system.

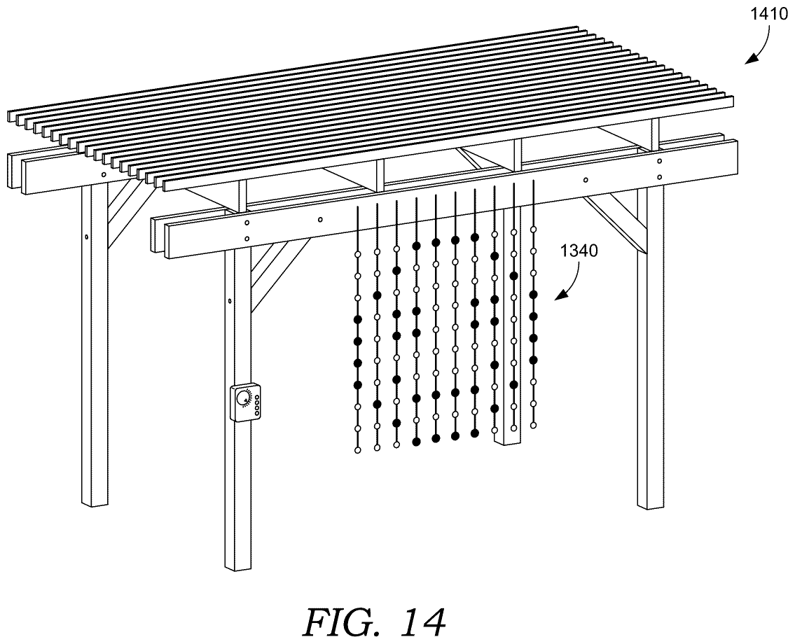

Moving to FIG. 14, an example structure and combination of modules is depicted in accordance with aspects described herein. In some embodiments, the structure network gateway 224 may be associated with any form of structure, or any number of structures. For example, the structure network gateway 224 may be associated with a structure such as the pergola 1410 as shown in FIG. 14. The pergola 1410 may be a free standing structure or may be attached to other structures. This pergola 1410 may be associated with the gateway, the control module, and any number of other control modules, such as the lighting control module, audio control module, and mechanical control module. The pergola 1410 may be associated with any number of modules, and each of these modules may be controlled by the control module. The modules and control modules may be physically attached to the pergola 1410 or may be parts which are not physically attached to the pergola 1410. Each of the modules may be communicatively connect. Additionally, the pergola 1410 structure is provided as an example structure with which the modules and features discussed herein may be associated with. The associated structure may be a patio, room, shed, or any outdoor or indoor structure. Additionally, the assignable LED strips 1340 may be attached or affixed to the example pergola 1410 or any other associated structure. The assignable LED strips as well as any other module may be located and attached or affixed to any location on the pergola 1410.

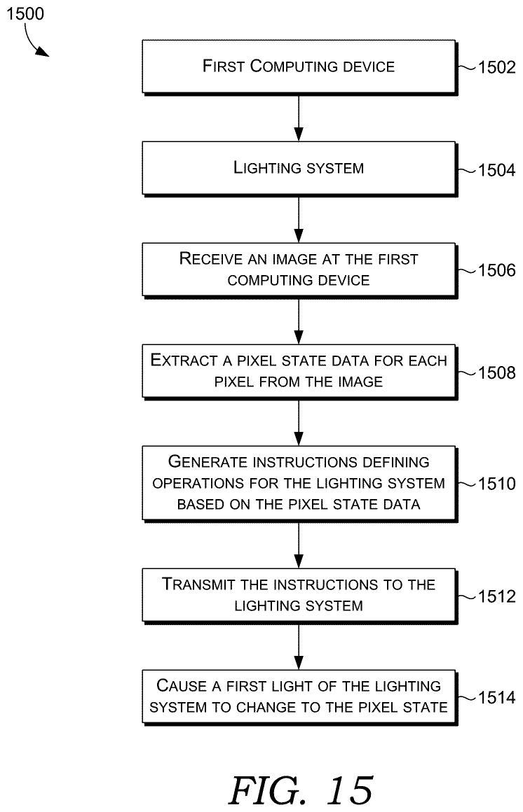

With general reference to FIGS. 15, 16, and 17, example methods for communicating and executing state changes for integrated structural devices are depicted in accordance with aspects described herein. Each block of methods 1500, 1600, and 1700 may comprise a computing process performed using any combination of hardware, firmware, or software. For instance, method 1500, 1600, and 1700 can be carried out by a processor executing instructions stored in memory. Method 1500, 1600, and 1700 can also be embodied as computer-usable instructions stored on computer storage media. Method 1500, 1600, and 1700 can be provided by a standalone application, a service or hosted service (standalone or in combination with another hosted service), or a plug-in to another product, to name a few possibilities.

Turning to FIG. 15, an example system flow schematic 1500 for communicating instructions to a lighting system is depicted, in accordance with one or more embodiments. It is to be understood that the system flow schematic 1500 may be executed on a system comprised of a first computing device 1502. The first computing device 1502 may be communicatively connected to a network and configured to receive an image via the network. The system may also comprise a lighting system 1504. The lighting system 1504 may be communicatively connected at least one adjustable light In embodiments, the system also comprises a, a non-transitory computer storage media storing executable instruction, that when executed by one or more processors of the first wireless communication device, cause a computing device to perform any number of operations.

At step 1506, the system is configured to receive an image at the first computing device. The image may including a set of pixels. In some embodiments, the first computing device may be a master control module as discussed in relation to the touchscreen master control module of FIG. 3, or the tactile master control module of FIG. 4. The first computing device may be configured to store any number of images received from any number of devices or sources. In some embodiments, the images may be received from a user computing device such as a smart phone or a computing tablet. In some embodiments, the images may be received directly from a server or from an internet source. As discussed in more detail above, the first computing device may additionally or alternatively be configured to adjust the pixel number and features of an image for example through downsampling.

In some embodiments, the image may be associated with any number of pixels having any number of pixel states. In additional or alternative embodiments, the pixels may be arranged in any format and any dimension. For example, the image may be a low resolution picture of a yellow and black smiley face. In this embodiment, the image may comprise a square format of pixels and only the colors yellow and black. In additional or alternative embodiments, the image may be of a sunset having a multitude of colors and other characteristics. In this embodiment, the image may be comprised of a landscape or rectangular format of pixels and a multitude of hue values, brightness levels, and saturation values.

At a step 1508, a pixel state is extracted for each pixel from the image. In embodiments, a pixel state data for each pixel of the set of pixels, is extracted from the image, wherein each of the pixel state data define a pixel state comprised of characteristics of a pixel. The pixel states for each pixel of the set of pixels may include any number of characteristics such as hue, saturation or brightness and each characteristic may be represented by a value which may be defined, determined, transmitted or received by computing devices in order to change the state of computing devices, such as the integrated structural devices, to change state based on the pixel state. For example, the hue values, saturation values, and brightness values of the pixel states of the set of pixels may be utilized to change any number of lights associated with a lighting system from an initial state to a state represented by the combination of hue value, saturation value, and brightness value of any number of pixel states. An image may be comprised of any number of pixels and a pixel state may be determined for each of these pixels. For example the image may be comprised of one hundred horizontal pixels by one hundred vertical pixels or may be comprised of one thousand horizontal pixels by one thousand vertical pixels. The image and its associated pixels may also be compressed or downsampled such that the dimensions of the pixels match the dimensions of the lights associated with the lighting system. For example if there are one thousand horizontal lights by one thousand vertical lights, but there are only one hundred horizontal lights by one hundred vertical lights, the image may be compress or downsampled using any known method so that there are one hundred horizontal pixels by one hundred vertical pixels. The pixel states for each of these pixels may be determined and used to cause a change to one hundred horizontal lights by one hundred vertical lights.

At a step 1510, instructions defining operations for the lighting system are generated based on the pixel state data. In embodiments the set of instructions defining operations for the lighting system is generated, where the set of instructions change the state of at least one light associated with the lighting system from an initial state to a pixel state of a first pixel of the set of pixels. In some embodiments, the set of instructions are configured to be communicated to the lighting system wherein the lighting system is a separate lighting control component or is a lighting control component that is integrated into the first computing device. At a step 1512, the set of instructions are transmitted to the lighting system. In some embodiments the instructions may be transmitted over a network such as the network discussed in relation to FIG. 2 and FIG. 3. In some embodiments, the instructions may be transmitted utilizing a local area network/Wi-Fi Network such as that discussed in relation to FIG. 2.

In some embodiments, the image may be associated with a first pixel position and a last pixel position and the lighting system may be associated with a first light position and a second light system. The first light may for example correspond to the light located in the top left corner of a set of lights and the last light may correspond to the bottom left corner of the set of lights. The first pixel may correspond to the pixel located in the top left corner of an image and the last pixel may correspond to the pixel located in the bottom right of the image. The instructions may be configured to cause a first light to change to the state of a first pixel, the second light to change to the state of a second pixel, and so on including changing the last light to a state of the last pixel. In additional or alternative embodiments, the instructions may include changing a first light to a first pixel state and then the second light to the first pixel state and the third light to a first pixel state. In this example, the image may appear to flow or travel across the set of lights horizontally, vertically, or diagonally to give the appearance of the image passing through the view represented by the lights.

At a step 1514, a first light of the lighting system is caused to change to the pixel state. In embodiments, the first light associated with the lighting system is caused to change from an initial state to the pixel state of the first pixel of the set of pixels. The initial state of the first light may be a predetermined hue value, saturation value, or brightness value. For example, the first light may be preset to a dim white light with corresponding hue, saturation and brightness values. Cause the first light to change from this initial state to a state of the first pixel may comprise changing from the dim white light to a bright orange light corresponding to a pixel in the image. Any number of lights may be caused to change to any number of pixel states of any number of pixels. For example, the set of instructions may comprise information related to any number of pixel states and any number of lights and these instructions may be utilized to change the states of any number of lights. For example, a set of one hundred vertical lights by one hundred vertical lights may be changed from a first state to a pixel state that corresponds to a set of one hundred vertical pixels by one hundred horizontal pixels. This may for example display a smiley face, animal, sunset, or any other image on the lights which corresponds to the image comprised of pixels. In additional or alternative embodiments, the instructions may further comprise a predetermined time interval at which at the first light associated with the lighting system will return to the initial state.

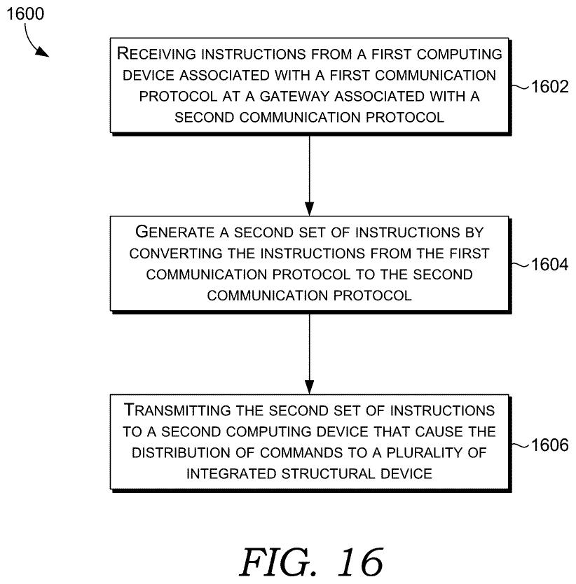

Turning to FIG. 16, an example method 1600 for communicating instructions to a plurality of integrated structural devices is depicted, in accordance with one or more embodiments. At a step 1602, instructions are received from a first computing device associated with a first communication protocol at a gateway associated with a second communication protocol. In embodiments, the set of instruction originate from a first computing device associated with a first network having a first communication protocol and are received by a gateway communicatively coupled to a second network having a second communication protocol. In some embodiments, the gateway may correspond to the structure network gateway which may be integrated into the master control module, located at a separate server, or may be an independent computer module separate from the master control module. The first communication device may be any computing device configured to communicate over a network such as a laptop, smartphone, or tablet. The first communication protocol may be any form of communication that is usable by the first computing device in order to transmit information across a telecommunication or wireless network. The second communication protocol may be any communication protocol which may be utilized by a local network such as a local area network/Wi-Fi network, Bluetooth network, or any form of Internet of Things communication.

At step 1604, a second set of instructions is generated by converting the set of instructions from the first communication protocol to the second communication protocol. At a step 1606, the second set of instructions is transmitted to a second computing device associated with the second network, wherein receipt of the transmitted set of instructions causes the second computing device to distribute commands to a plurality of integrated structural devices, the distributed commands causing at least one of the plurality of integrated structural devices to change from a first state to a second state. In some embodiments, the second communication device may transmit instruction to various control components which are physically separate from the second communication device, or may utilize various control components integrated into the second communication device in order to make changes in a plurality of integrated structural devices.

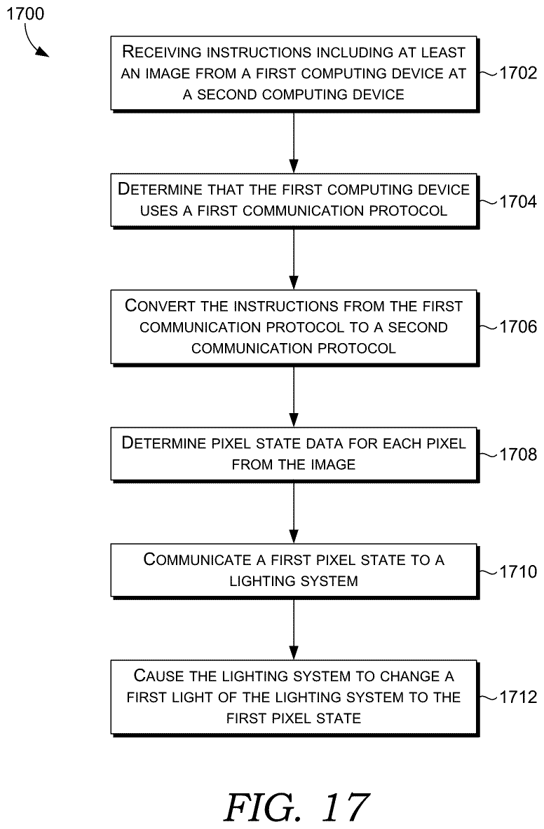

Turning to FIG. 17, an example method 1700 of an additional or alternative method for communicating instructions to a lighting system in accordance with one or more embodiments is shown. At a first step 1702, instructions which include at least one image are received from a first computing device at a second computing device. In embodiments, a set of instructions comprising at least an image associated with a set of pixels is received from a first computing device communicatively coupled to a first communication network at a second computing device communicatively coupled to a second communication network. At a step 1704, it is determined that the first computing device is utilizing a first communication protocol. At a step 1706, the instructions are converted from the first communication protocol to a second communication protocol. In embodiments, based on determining that the first computing device is utilizing a first communication protocol, the instructions are converted from the first communication protocol to a second communication protocol. At a step 1708, pixel state data is determined for each pixel from the image. In embodiments, based on converting the instructions, a pixel state data for each pixel of the set of pixels, is determined wherein each of the pixel state data defines a pixel state comprised of characteristics of a pixel. At a step 1710, a first pixel state of a first pixel of the set of pixels is communicated to a lighting system. At a step 1712, based on communicating the first pixel state, the lighting system is caused to change a first light of a set of lights from an initial state to the pixel state.

As used herein and in connection with the claims listed hereinafter, the terminology “any of clauses” or similar variations of the terminology is intended to be interpreted such that features of claims/clauses may be combined in any combination. For example, an example clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of the terminology is intended to include “any one of clauses” or other variations of such terminology, as indicated by some of the examples provided above.

Clause 1. A system comprising: a first computing device communicatively connected to a network, and configured to receive an image via the network; a lighting system connected to the network comprised of at least one adjustable light; and non-transitory computer storage media storing executable instruction, that when executed by one or more processors of the first wireless communication device, cause the first wireless communication device to perform operations comprising: receive, at the first computing device, an image including a set of pixels; extracting from the image a pixel state data for each pixel of the set of pixels, each of the pixel state data defining a pixel state comprised of characteristics of a pixel; generating a set of instructions defining operations for the lighting system, wherein the set of instructions change the state of a first light associated with the lighting system from an initial state to a pixel state of a first pixel of the set of pixels; transmitting the set of instructions to the lighting system; and causing a first light associated with the lighting system to change from an initial state to the pixel state of the first pixel of the set of pixels.

Clause 2. The system of clause 1, wherein causing at least one light associated with the lighting system to change from the initial state to the pixel state of the first pixel comprises changing at least one of a hue, a saturation or a brightness of the first light to a hue value, a saturation value, or a brightness value of the first pixel.

Clause 3. The system of clause 1, wherein the lighting system includes at least a first lighting position and a last lighting position and the set of pixels includes at least a first pixel position and a last pixel position and wherein the first light is associated with the first lighting position and the first pixel is associated with the first pixel position.

Clause 4. The system of clause 3, further comprising causing a second light associated with a second lighting position to change from an initial state to the pixel state of the first pixel, and causing the first light associated with the first lighting position to change from the pixel state of the first pixel to a pixel state of the a last pixel associated with the last pixel position.

Clause 5. The system of clause 3, further comprising causing a last light associated with a last light position to change from an initial state to a pixel state of a pixel associated with the last pixel position

Clause 6. The system of clause 1, further comprising a third wireless communication device associated with an audio control component.

Clause 7. The system of clause 6, wherein the instructions further define operations for the audio control component, wherein the set of instructions changes at least one speaker associated with the audio control component to change from an inactive state to an active state.

Clause 8. The system of clause 1, wherein the pixel state of each pixel of the set of pixels comprises a hue value, a saturation value, or a brightness value.

Clause 9. The system of clause 1, wherein the instructions further comprise a predetermined time interval at which the first light associated with the lighting system will return to the initial state.

Clause 10. A method comprising: receiving a set of instructions originating from a first computing device associated with a first network having a first communication protocol, by a gateway communicatively coupled to a second network having a second communication protocol; generating a second set of instructions by converting the set of instruction from the first communication protocol to the second communication protocol; and transmitting the second set of instructions to a second computing device associated with the second network, wherein receipt of the transmitted set of instructions causes the second computing device to distribute commands to a plurality of integrated structural devices, the distributed commands causing at least one of the plurality of integrated structural devices to change from a first state to a second state.

Clause 11. The method of clause 10, wherein the second communication device is a lighting control component

Clause 12. The method of clause 10 wherein the second computing device is a master control module

Clause 13. The method of clause 10, wherein the at least one of the plurality of integrated structural devices include a heater, a fan, or addressable LED strip lights.

Clause 14. Computer-readable storage media having computer-executable instructions embodied thereon that, when executed by one or more processors, cause the one or more processors to: receive a set of instructions, comprising at least an image associated with a set of pixels from a first computing device communicatively coupled to a first communication network at a second computing device communicatively coupled to a second communication network; determine that the first computing device is utilizing a first communication protocol; based on determining that the first computing device is utilizing a first communication protocol, convert the instructions from the first communication protocol to a second communication protocol; based on converting the instructions; determine a pixel state data for each pixel, each of the pixel state data defining a pixel state comprised of characteristics of a pixel; communicate a first pixel state of a first pixel of the set of pixels to a lighting system; and based on communicating the first pixel state, causing the lighting system to change a first light of a set of lights from a first state to the pixel state.

Clause 15. The computer-readable storage media of clause 14, wherein the instructions further comprise a predetermined time interval at which the first light associated with the lighting system will return to the initial state

Clause 16. The computer-readable storage media of clause 14, wherein the pixel state data for each pixel comprises a hue value, a saturation value, or a brightness value.

Clause 17. The computer-readable storage media of claim 14, wherein the pixel state data for each pixel comprises a hue value, a saturation value, or a brightness value.

Clause 18. The computer-readable storage media of clause 17, wherein the instructions further comprise audio data.

Clause 19. The computer-readable storage media of clause 18, further comprising communicating the audio data to the audio control component.

Clause 20. The computer-readable storage media of clause 14, wherein the lighting system includes at least a first lighting position and a last lighting position and the set of pixels includes at least a first pixel position and a last pixel position and wherein the first light is associate with the first lighting position and the first pixel is associated with the first pixel position.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system comprising:
a first computing device communicatively connected to a network, and configured to receive an image via the network;
a lighting system connected to the network comprised of at least one adjustable light; and
non-transitory computer storage media storing executable instruction, that when executed by one or more processors of the first wireless communication device, cause the first wireless communication device to perform operations comprising:
receive, at the first computing device, an image including a set of pixels;
extracting from the image a pixel state data for each pixel of the set of pixels, each of the pixel state data defining a pixel state comprised of characteristics of a pixel;
generating a set of instructions defining operations for the lighting system, wherein the set of instructions change the state of a first light associated with the lighting system from an initial state to a pixel state of a first pixel of the set of pixels;
transmitting the set of instructions to the lighting system; and
causing a first light associated with the lighting system to change from an initial state to the pixel state of the first pixel of the set of pixels.

2. The system of claim 1, wherein causing at least one light associated with the lighting system to change from the initial state to the pixel state of the first pixel comprises changing at least one of a hue, a saturation or a brightness of the first light to a hue value, a saturation value, or a brightness value of the first pixel.

3. The system of claim 1, wherein the lighting system includes at least a first lighting position and a last lighting position and the set of pixels includes at least a first pixel position and a last pixel position and wherein the first light is associated with the first lighting position and the first pixel is associated with the first pixel position.

4. The system of claim 3, further comprising causing a second light associated with a second lighting position to change from an initial state to the pixel state of the first pixel, and causing the first light associated with the first lighting position to change from the pixel state of the first pixel to a pixel state of the a last pixel associated with the last pixel position.

5. The system of claim 3, further comprising causing a last light associated with a last lighting position to change from an initial state to a pixel state of a pixel associated with the last pixel position.

6. The system of claim 1, further comprising a third wireless communication device associated with an audio control component.

7. The system of claim 6, wherein the instructions further define operations for the audio control component, wherein the set of instructions changes at least one speaker associated with the audio control component to change from an inactive state to an active state.

8. The system of claim 1, wherein the pixel state of each pixel of the set of pixels comprises a hue value, a saturation value, or a brightness value.

9. The system of claim 1, wherein the instructions further comprise a predetermined time interval at which the first light associated with the lighting system will return to the initial state.

10. A method comprising:
receiving a set of instructions originating from a first computing device associated with a first network having a first communication protocol, by a gateway communicatively coupled to a second network having a second communication protocol;
generating a second set of instructions by converting the set of instruction from the first communication protocol to the second communication protocol; and
transmitting the second set of instructions to a second computing device associated with the second network, wherein receipt of the transmitted set of instructions causes the second computing device to distribute commands to a plurality of integrated structural devices, the distributed commands causing at least one of the plurality of integrated structural devices to change from a first state to a second state.

11. The method of claim 10, wherein the second computing device is a lighting control component.

12. The method of claim 10, wherein the second computing device is a master control module.

13. The method of claim 10, wherein the at least one of the plurality of integrated structural devices include a heater, a fan, or addressable LED strip lights.

14. Computer-readable storage media having computer-executable instructions embodied thereon that, when executed by one or more processors, cause the one or more processors to:
receive a set of instructions, comprising at least an image associated with a set of pixels from a first computing device communicatively coupled to a first communication network at a second computing device communicatively coupled to a second communication network;
determine that the first computing device is utilizing a first communication protocol;
based on determining that the first computing device is utilizing a first communication protocol, convert the instructions from the first communication protocol to a second communication protocol;
based on converting the instructions;
determine a pixel state data for each pixel, each of the pixel state data defining a pixel state comprised of characteristics of a pixel;
communicate a first pixel state of a first pixel of the set of pixels to a lighting system; and
based on communicating the first pixel state, causing the lighting system to change a first light of a set of lights from a first state to the pixel state.

15. The computer-readable storage media of claim 14, wherein the instructions further comprise a predetermined time interval at which the first light associated with the lighting system will return to the initial state.

16. The computer-readable storage media of claim 14, wherein the pixel state data for each pixel comprises a hue value, a saturation value, or a brightness value.

17. The computer-readable storage media of claim 14, further comprising a third communication device comprised of an audio control component.

18. The computer-readable storage media of claim 17, wherein the instructions further comprise audio data.

19. The computer-readable storage media of claim 18, further comprising communicating the audio data to the audio control component.

20. The computer-readable storage media of claim 14, wherein lighting system includes at least a first lighting position and a last lighting position and the set of pixels includes at least a first pixel position and a last pixel position and wherein the first light is associated with the first lighting position and the first pixel is associated with the first pixel position.
